(19) United States
(12) Patent Application Publication
(10) Pub. No.: US 2005/0053420 A1
(43) Pub. Date: Mar. 10, 2005

(54) Ball joint seal for a ball joint assembly

(76) Inventor: Brian Blaszynski, St. Catharines (CA)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/928,606

(22) Filed: Aug. 27, 2004

Related U.S. Application Data
(60) Provisional application No. 60/498,937, filed on Aug. 29, 2003.

(51) Int. Cl. F16D 1/12

(52) U.S. Cl. 403/122

(57) ABSTRACT

This invention relates to an improved ball joint seal of a ball joint assembly adapted for use in a motor vehicle. The ball joint assembly includes a housing defining a socket chamber and having an opening; a ball joint bearing disposed within the socket chamber; a ball stud supported by the ball joint bearing, the ball stud having a shank portion which projects through the opening of the housing; and a ball joint seal adapted to seal the opening between the ball stud and the socket chamber; wherein the ball joint seal includes a first portion having a first reinforcing ring disposed therein to hold an upper end portion of the ball joint seal in sealing engagement with the shank portion of the ball stud, and a second portion having a second reinforcing ring disposed therein to hold a lower end portion of the ball joint seal in sealing engagement with the housing.

### CROSS-REFERENCE TO RELATED APPLICATIONS

This application claims the benefit of U.S. Provisional Application Ser. No. 60/498,937, filed Aug. 29, 2003.

### BACKGROUND OF THE INVENTION

This invention relates in general to a ball joint assembly for use in a vehicle suspension system and in particular to an improved ball joint seal for use with such a ball joint assembly.

A ball joint assembly provides an articulated connection between two relatively movable parts. A ball joint assembly is commonly used in motor vehicle steering systems and in motor vehicle suspension systems. Typically, a ball joint assembly for a motor vehicle suspension system includes a ball stud with a spherical ball end and a housing or socket member with a spherical socket. A ball joint bearing member disposed in the housing receives the ball end and supports the ball end for pivotal and rotational movement.

### SUMMARY OF THE INVENTION

This invention relates to an improved ball joint seal of a ball joint assembly adapted for use in a motor vehicle. The ball joint assembly includes a housing defining a socket chamber and having an opening; a ball joint bearing disposed within the socket chamber; a ball stud supported by the ball joint bearing, the ball stud having a shank portion which projects through the opening of the housing; and a ball joint seal adapted to seal the opening between the ball stud and the socket chamber; wherein the ball joint seal includes a first portion having a first reinforcing ring disposed therein to hold an upper end portion of the ball joint seal in sealing engagement with the shank portion of the ball stud, and a second portion having a second reinforcing ring disposed therein to hold a lower end portion of the ball joint seal in sealing engagement with the housing.

Other advantages of this invention will become apparent to those skilled in the art from the following detailed description of the preferred embodiment, when read in light of the accompanying drawings.

### BRIEF DESCRIPTION OF THE DRAWINGS

FIG. 1 is a sectional view of a ball joint assembly including a first embodiment of a ball joint seal in accordance with the present invention.

FIG. 2 is a plan view of the ball joint seal shown in FIG. 1.

FIG. 3 is a section view taken along line 3-3 of FIG. 2.

FIG. 4 is a view of a portion of a reinforcing ring of the ball joint seal shown in FIGS. 1-3.

FIG. 5 is a section view of a second embodiment of a ball joint seal in accordance with the present invention.

### DETAILED DESCRIPTION OF THE PREFERRED EMBODIMENTS

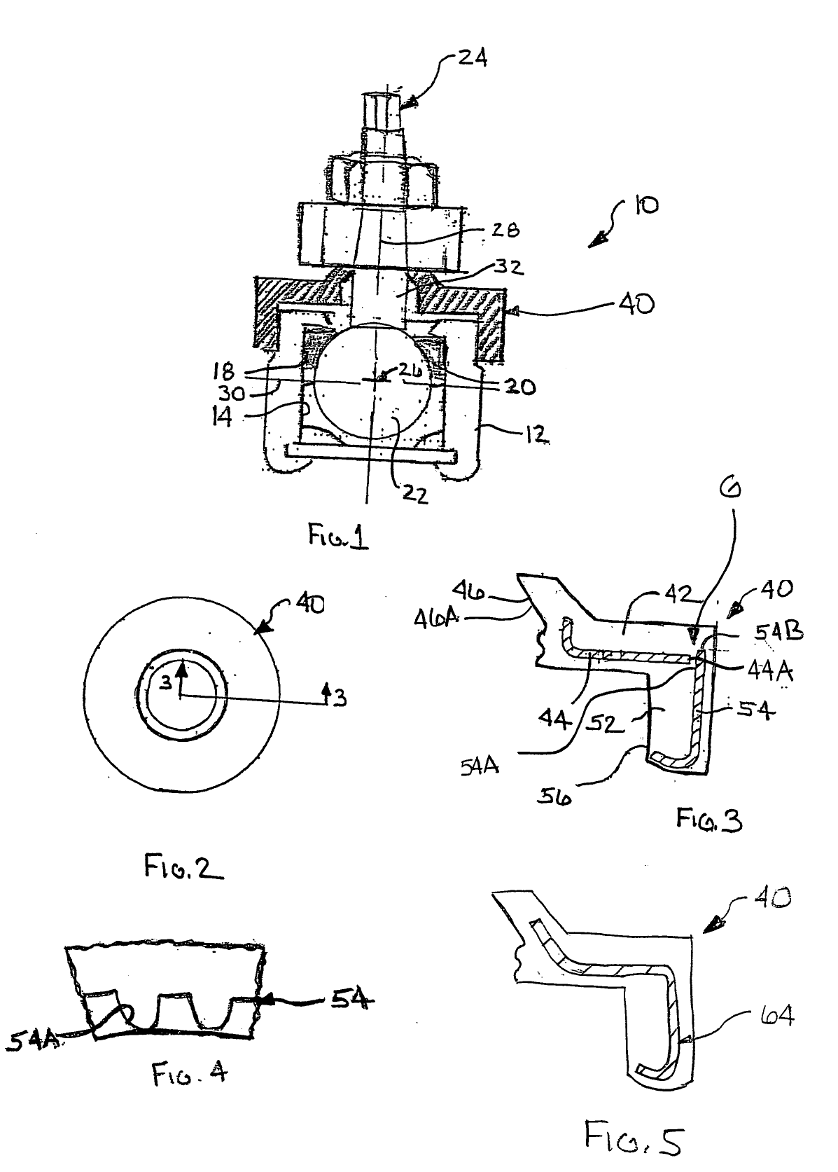

Referring now to FIG. 1, there is illustrated a ball joint assembly, indicated generally at 10, including a ball joint seal, indicated generally at 40, in accordance with the present invention. The general structure and operation of the ball joint assembly 10 is conventional in the art. Thus, only those portions of the ball joint assembly 10 which are necessary for a full understanding of this invention will be explained and illustrated in detail. Also, although this invention will be described and illustrated in connection with the particular ball joint assembly 10 disclosed herein, it will be appreciated that this invention may be used in connection with other types of ball joint assemblies. For example, the ball joint seal 40 of the present invention can be used in conjunction with any of the ball joint assemblies shown in U.S. Pat. No. 5,066,159 to Urbach, U.S. Pat. No. 5,380,114 to Urbach, U.S. Pat. No. 5,678,947 to Urbach et al., U.S. Pat. No. 5,931,597 to Urbach, and U.S. Pat. No. 6,042,294 to Urbach, the disclosures of each of these patents incorporated herein by reference.

The illustrated ball joint assembly 10 includes a rigid metal housing or socket member 12 having a generally cylindrical side wall 14. The housing 12 defines a generally cylindrical socket chamber 18 within which is located a ball joint bearing 20. The housing 12 is made by a suitable process from a suitable material. For example, the housing 12 can be cold formed from SAE grade 1008 or 1010 steel or screw machined from SAE grade 1215 or 1018 steel.

The ball joint bearing 20 supports a spherical ball portion 22 of a ball stud 24. The ball joint bearing 20 supports the ball stud 24 for limited rotation and pivoting movement about a center of oscillation 26, which is the intersection of a longitudinal axis 28 and a transverse axis 30 of the ball stud 24. The center of oscillation 26 is coincident with the center of the spherical ball portion 22 of the ball stud 24. The ball stud 24 is made by a suitable process from a suitable material. For example, the ball stud 24 can be cold headed or screw machined and then carburized from SAE grade 8115M or 8615 steel. The ball stud 24 includes a shank portion 32 which projects through a generally circular opening formed in an upper (as viewed in FIG. 1) end portion of the housing 12.

The ball joint 10 further includes the ball joint seal 40. The ball joint seal 40 is a generally annular seal and is provided to seal the opening between the ball stud 24 and the housing 12. As best shown in FIGS. 2 and 3, the ball joint seal 40 includes a first portion 42 having a generally annular metal reinforcing ring 44 disposed therein by a suitable process, such as for example, by an insitu or injection molding process. The ring 44 exerts a generally radially inwardly biasing force on an upper end portion 46 of the first portion 42 of the ball joint seal 40 which is operative to hold or support the upper end portion 46 of the ball joint seal 40 in sealing engagement with the shank portion 32 of the ball stud 24. In the illustrated embodiment, the upper end portion 46 includes a conical inner surface 46A and the ring 44 is generally L-shaped. The conical inner surface 46A of the upper end portion 46 is operative to provide a first or initial self-centering feature by the material of the seal itself. Alternatively, the structure of the upper end portion 46 and/or the ring 44 can be other than illustrated if so desired.

The ball joint seal 40 further includes a second portion 52 having a generally annular metal reinforcing ring 54 disposed therein by a suitable process, such as for example, by an insitu or injection molding process. The ring 54 exerts a generally radially inwardly biasing force on a lower end portion 56 of the second portion 52 of the ball joint seal 40 which is operative to hold or support the lower end portion 56 of the ball joint seal 40 in sealing engagement with the housing 12. In the illustrated embodiment, the ring 54 is generally J-shaped.

In the illustrated embodiment, an end 44A of the ring 44 is spaced apart from a surface 54A of the ring 54 by a distance or gap G. Also, as shown in FIG. 3, the ring 54 extends upwardly past the end 44A of the ring 44 so that an end 54B of the ring 54 is located above the ring 44. As a result of this, upon further displacement of the seal 40, the ring 44 will also assist in providing a self-centering feature of the seal 40. Furthermore, additional displacement will cause the gap G to become smaller and the end 44A of the ring 44 to move closer to the surface 54A of the ring 54 so that the ring 54 will also assist in providing a self-centering feature of the seal 40. Alternatively, the structure of the ring 54 can be other than illustrated if so desired. Also, the gap G and the distance that the end 54B extends upwardly past the ring 44 can be other than illustrated if so desired.

Preferably, the first portion 42 and the second portion 52 of the ball joint seal 40 are formed from a suitable material, such as for example, a suitable elastomeric material, such as, such as Neoprene which is available from Dupont. Alternatively, the portions 42 and 52 can be made from other suitable materials if so desired.

Also, as shown in FIG. 4, in this embodiment, the ball joint seal 40 is preferably provided with a plurality of evenly spaced cut-outs 54A at an outermost end of the ring 54. In this embodiment, the cut-outs 54A resemble a generally scalloped design to provide a purgeable type seal to allow excess grease and pressure to be relieved and/or to facilitate servicing. Alternatively, the shape, spacing, number and/or location of the cut-outs 54A can be other than illustrated if so desired. Alternatively, the ball joint seal 40 can have a different construction and/or can be formed from other suitable materials if so desired. For example, as shown in the embodiment illustrated in FIG. 5, the ball joint seal 40 could include a integral one-piece reinforcing ring 64 having a desired shape, such as that shown therein.

One advantage of the ball joint seal 40 of the present invention is that it combines lubed for life capability with self-centering and anti-tilt capabilities. The ring 54 fixes the ball joint seal 40 to the housing 12 of the ball joint assembly 10 and also provides stiffness to absorb rocking movement of the ball stud 24. The ring 44, along with the upper end 46 or throat support of the ball joint seal 40, provides a recentering action of the design of the ball joint seal 40 of the invention. Under low rocking type action, the lateral displacement of the throat 46 (initially) and then the ring 44 results in stored energy. This stored energy recenters the ball stud 24 when the rocking force is removed. Additionally, the dampening properties of the ball joint seal material (i.e., the engineered rubber compound), absorbs the energy of the rocking action. If the rocking action gets too large the higher energy is dissipated as the steering knuckle boss contacts the top of the seal material covering the ring 44. The ball joint seal 40 of the present invention also provides progressive articulation resistance as the articulation is increased. This provides better steering feeling during regular vehicle operation. When road inputs arise that induce rocking action in the steering linkage the dual action resistance of the ball joint seal 40 of the present invention provides resistive force proportional to the input. Also, the ring 54 supports the ball joint seal 40 and fixes the ball joint seal 40 seal to the housing 12. This provides a water-tight seal and allows for lubed for life capability.

In accordance with the provisions of the patent statutes, the principle and mode of operation of this invention have been described and illustrated in its preferred embodiments. However, it must be understood that this invention may be practiced otherwise than as specifically explained and illustrated without departing from its spirit or scope.

1. A ball joint assembly adapted for use in a motor vehicle comprising:
a housing defining a socket chamber and having an opening;
a ball joint bearing disposed within said socket chamber;
a ball stud supported by said ball joint bearing, said ball stud having a shank portion which projects through said opening of said housing; and
a ball joint seal adapted to seal said opening between said ball stud and said socket chamber;
wherein said ball joint seal includes a first portion having a first reinforcing ring disposed therein to hold an upper end portion of said ball joint seal in sealing engagement with said shank portion of said ball stud, and a second portion having a second reinforcing ring disposed therein to hold a lower end portion of said ball joint seal in sealing engagement with said housing.

2. The ball joint assembly according to claim 1 wherein said second reinforcing ring includes an outermost end having a plurality of cut-outs formed therein.

3. The ball joint assembly according to claim 1 wherein said first reinforcing ring includes an end spaced apart from an adjacent surface of said second reinforcing ring.

4. The ball joint assembly according to claim 1 wherein said first portion includes a generally conical shaped inner surface.

5. The ball joint assembly according to claim 1 wherein said ball joint seal is formed from an elastomeric material and said first reinforcing ring and said second reinforcing ring are disposed in said elastomeric material of said ball joint seal by a molding process.

6. The ball joint assembly according to claim 1 wherein said first reinforcing ring and said second reinforcing ring are separately formed.

7. The ball joint assembly according to claim 1 wherein said first reinforcing ring is generally L-shaped.

8. The ball joint assembly according to claim 1 wherein said second reinforcing ring is generally J-shaped.

9. The ball joint assembly according to claim 1 wherein said first reinforcing ring and said second reinforcing ring are integrally formed.

10. A ball joint assembly adapted for use in a motor vehicle comprising:
a housing defining a socket chamber and having an opening;
a ball joint bearing disposed within said socket chamber;
a ball stud supported by said ball joint bearing, said ball stud having a shank portion which projects through said opening of said housing; and
a ball joint seal formed from an elastomeric material and adapted to seal said opening between said ball stud and said socket chamber;
wherein said ball joint seal includes a first portion having a first metal reinforcing ring disposed therein to hold an upper end portion of said ball joint seal in sealing engagement with said shank portion of said ball stud, and a second portion having a second metal reinforcing ring disposed therein to hold a lower end portion of said ball joint seal in sealing engagement with said housing, and wherein said first reinforcing ring includes an end spaced apart from an adjacent surface of said second reinforcing ring.

11. The ball joint assembly according to claim 10 wherein said second reinforcing ring includes an outermost end having a plurality of cut-outs formed therein.

12. The ball joint assembly according to claim 10 wherein said first reinforcing ring and said second reinforcing ring are separately formed.

13. The ball joint assembly according to claim 10 wherein said first reinforcing ring and said second reinforcing ring are integrally formed.

14. A ball joint seal adapted for use in a ball joint assembly for use in a motor vehicle comprising:
a ball joint seal including a first portion having a first reinforcing ring disposed therein and a second portion having a second reinforcing ring disposed therein, said first reinforcing ring including an end spaced apart from an adjacent surface of said second reinforcing ring.

15. The ball joint seal according to claim 14 wherein said second reinforcing ring includes an outermost end having a plurality of cut-outs formed therein.

16. The ball joint seal according to claim 14 wherein said first reinforcing ring is a generally annular metal reinforcing ring.

17. The ball joint seal according to claim 14 wherein said second reinforcing ring is a generally annular metal reinforcing ring.

18. The ball joint seal according to claim 14 wherein said ball joint seal is formed from an elastomeric material and said first reinforcing ring and said second reinforcing ring are disposed in said elastomeric material of said ball joint seal by a molding process.

19. The ball joint seal according to claim 14 wherein said first reinforcing ring and said second reinforcing ring are separately formed.

20. The ball joint seal according to claim 14 wherein said first reinforcing ring and said second reinforcing ring are integrally formed.
